(19) United States
(12) Patent Application Publication
(10) Pub. No.: US 2008/0303586 A1
(43) Pub. Date: Dec. 11, 2008

(54) Negative voltage generating circuit

(75) Inventor: Zhong-Ru Li, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/156,990

(22) Filed: Jun. 6, 2008

(30) Foreign Application Priority Data
Jun. 8, 2007 (CN) 200710074776.8

(51) Int. Cl. G05F 1/10

(52) U.S. Cl. 327/536

(57) ABSTRACT

An exemplary negative voltage generating circuit includes a voltage input, a first switch transistor, a second switch transistor, a third switch transistor, a fourth switch transistor, a first capacitor, a second capacitor, a switch controller, and a voltage output. The voltage input is connected to ground via the first switch transistor, the first capacitor, and a source electrode and the second switch transistor. The first switch transistor is connected to the second switch transistor via the third switch transistor, the second capacitor, and the fourth switch transistor. The third switch transistor is connected to ground. The fourth switch transistor is connected to the voltage output. The first switch transistor, the second switch transistor, the third switch transistor, and the fourth switch transistor are connected to the switch controller.

### FIELD OF THE INVENTION

The present invention relates to negative voltage generating circuits, and more particularly, to a negative voltage generating circuit used in a liquid crystal display (LCD).

### GENERAL BACKGROUND

Because LCDs have the advantages of portability, low power consumption, and low radiation, they have been widely used in various portable information products such as notebooks, personal digital assistants (PDAs), video cameras, and the like.

A typical LCD includes a power supply circuit. The power supply circuit supplies working voltages to the LCD when the LCD works. The LCD usually needs both a positive voltage and a negative voltage, yet most mains electrical sources provide only positive voltages. Therefore the power supply circuit of a typical LCD includes a negative voltage generating circuit that is capable of generating a negative voltage on receiving a positive voltage.

A typical negative voltage generating circuit utilizes components such as a pulse width modulator (PWM), windings, and other electronic parts. Accordingly, the cost of the negative voltage generating circuit is rather high.

What is needed, therefore, is a negative voltage generating circuit that can overcome the above-described deficiency.

### SUMMARY

In one preferred embodiment, a negative voltage generating circuit includes a voltage input, a first switch transistor, a second switch transistor, a third switch transistor, a fourth switch transistor, a first capacitor, a second capacitor, a switch controller, and a voltage output. The voltage input is connected to ground via a source electrode and a drain electrode of the first switch transistor, the first capacitor, and a source electrode and a drain electrode of the second switch transistor. The drain electrode of the first switch transistor is connected to the source electrode of the second switch transistor via a source electrode and a drain electrode of the third switch transistor, the second capacitor, a source electrode and a drain electrode of the fourth switch transistor. The drain of the third switch transistor is connected to ground. The source electrode of the fourth switch transistor is connected to the voltage output. The gates of the first switch transistor, the second switch transistor, the third switch transistor, and the fourth switch transistor are connected to the switch controller.

Other aspects, novel features and advantages will become more apparent from the following detailed description when taken in conjunction with the accompanying drawings.

### BRIEF DESCRIPTION OF THE DRAWINGS

FIG. 1 is a diagram of a negative voltage generating circuit according to a first embodiment of the present invention.

FIG. 2 is a schematic timing chart of voltages of the negative voltage generating circuit of FIG. 1.

FIG. 3 is a diagram of a negative voltage generating circuit according to a second embodiment of the present invention.

FIG. 4 is a schematic timing chart of voltages of the negative voltage generating circuit of FIG. 3.

### DETAILED DESCRIPTION OF PREFERRED EMBODIMENTS

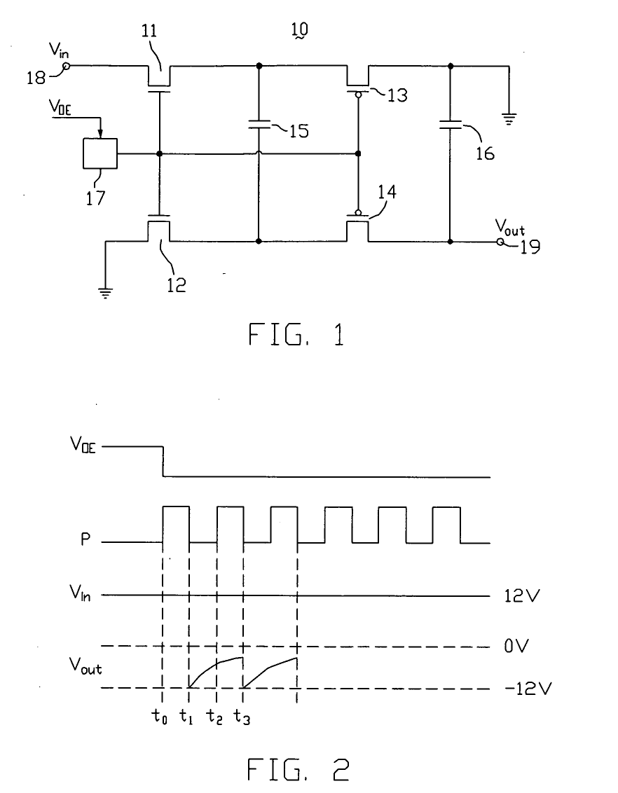

Referring to FIG. 1, a diagram of a negative voltage generating circuit 10 according to a first embodiment of the present invention is shown. The negative voltage generating circuit 10 is employed in a power supply circuit of an LCD (not shown). The negative voltage generating circuit 10 includes a first switch transistor 11, a second switch transistor 12, a third switch transistor 13, a fourth switch transistor 14, a first capacitor 15, a second capacitor 16, a switch controller 17, a voltage input 18, and a voltage output 19. Each of the first, second, third, and fourth switch transistors 11, 12, 13, 14 includes a gate electrode (not labeled), a source electrode (not labeled), and a drain electrode (not labeled).

The voltage input 18 is grounded via the source electrode and the drain electrode of the first switch transistor 11, the first capacitor 15, and the source electrode and the drain electrode of the second switch transistor 12. The drain electrode of the first switch transistor 11 is connected to the source electrode of the second switch transistor 12 via the source electrode and the drain electrode of the third switch transistor 13, the second capacitor 16, and the source electrode and the drain electrode of the fourth switch transistor 14. The drain of the third switch transistor 13 is grounded. The source of the fourth switch transistor 14 is connected the voltage output 19. The gate electrodes of the first to fourth switch transistors 11, 12, 13, 14 are connected to the switch controller 17.

The first and second switch transistors 11, 12 are N-channel metal oxide semiconductor (NMOS) type transistors. The third and fourth switch transistors 13, 14 are P-channel metal oxide semiconductor (PMOS) type transistors. The switch controller 17 is configured for providing a sequential control signal. The voltage input 18 has a constant direct current positive voltage applied thereto. The voltage output 19 outputs a negative voltage.

Referring also to FIG. 2, this is a schematic timing chart of voltage signals of the negative voltage generating circuit 10. V_{OE} represents an operation-enable signal applied by an external circuit (not shown), which is operative to start the switch controller 17. P represents the control signal applied to the gate electrodes of the first to fourth switch transistors 11, 12, 13, 14, where the control signal P is a periodic square-wave. Vᵢₙ represents the constant direct current positive voltage applied to the voltage input 18, and the voltage Vᵢₙ can preferably be 12V. Vₒᵤₜ represents the negative voltage applied from the voltage output 19.

At the moment t₀, the switch controller 17 is started up by the operation-enable signal V_{OE}. The switch controller 17 applies the control signal P to the gate electrodes of the first to fourth switch transistors 11, 12, 13, 14.

During the period t0˜t1, the control signal P is at high-level (such as a positive voltage). The first and second switch transistors 11, 12 are switched on, and the third and fourth switch transistors 13, 14 are switched off. Thus, the voltage input 18 is grounded via the on-state first switch transistor 11, the first capacitor 15, and the on-state second switch transistor 12. The voltage Vᵢₙ is applied to the first capacitor 15. The first capacitor 15 is charged by the voltage Vᵢₙ, and electrical energy is stored therein. Thus, one end of the first capacitor 15 has a positive voltage equal to 12V.

During the period t₁˜t₂, the control signal P is at low-level (such as a negative voltage). Thus the first and second switch transistors 11, 12 are switched off. The third and fourth switch transistors 13, 14 are switched on. The first capacitor 15, the on-state third switch transistor 13, the second capacitor 16, and the on-state fourth switch transistor 14 cooperatively constitute a discharging loop circuit.

At the moment t1, the high-level end of the first capacitor 15 having 12V voltage is connected to ground via the third switch transistor 13. Thus, the other low-level end of the first capacitor 15 generates a corresponding negative 12V voltage due to a coupling effect of the first capacitor 15. Because the voltage output 19 is electrically connected to the other end of the first capacitor 15 via the on-state fourth switch transistor 14, the voltage output 19 has a negative 12V voltage Vₒᵤₜ output therefrom. After the moment t1, the second capacitor 16 is charged by the first capacitor 15, thus a voltage difference between high-level ends and low-level ends of the first capacitor 15 and the second capacitor 16 is gradually reduced. In other words, the negative 12V Vₒᵤₜ generated in the other low-level end of the first capacitor 15 gradually becomes greater albeit still less than 0V (see FIG. 2), and the voltage of the high-level end of the first capacitor 15 is still 0V.

During the period t₂˜t₃, the control signal P jumps to a positive voltage, the first and second switch transistors 11, 12 are switched on, and the third and fourth switch transistors 13, 14 are switched off. Thus, the first capacitor 15 is charged by the positive 12V voltage Vᵢₙ via the on-state first switch transistor 11. The second capacitor 16 gradually discharges, so that the negative voltage output Vₒᵤₜ continuously becomes greater and approaches below 0V.

At the moment t₃, the control signal P jumps to a low-level voltage. The first and second switch transistors 11, 12 are switched off. The third and fourth switch transistors 13, 14 are switched on. The voltage output 19 has a negative 12V voltage output. After the moment t3, the negative voltage generating circuit 10 repeats the working procedure of the period t₁˜t₃. Therefore, the voltage output 19 outputs a negative voltage continuously, namely the negative voltage Vₒᵤₜ. Therefore, the negative voltage Vₒᵤₜ is within a range from −12V to 0V. The period t₁˜t₃ is substantially a cycle period of the working procedure of the negative voltage generating circuit 10. Hereinafter, unless the context indicates otherwise, a “cycle period” refers to a cycle of the working procedure of the negative voltage generating circuit 10. It should be noted that the control signal P is at low-level during a first half of each cycle period, and is at high-level during a second half of each cycle period.

In summary, the first capacitor 15 is pre-charged by the positive voltage Vᵢₙ for half a cycle period (the period t₀˜t₁), discharges during the first half of a cycle period (such as the period t₁˜t₂), and is charged by the positive voltage Vᵢₙ during the second half of the cycle period (such as the period t₂˜t₃). The second capacitor 16 is charged by the first capacitor 15 during the first half of the cycle period (such as the period t₁˜t₂), and discharges during the second half of the cycle period (such as the period t₂˜t₃). The high-level ends of the first and second capacitors 15, 16 are connected to ground when discharging, so that the voltage output 19 can continuously apply the negative voltage Vₒᵤₜ due to the coupling effect. The negative voltage Vₒᵤₜ substantially jumps to −12V at the beginning of each cycle period, and gradually increases from −12V to a value approximately below 0V during each cycle period.

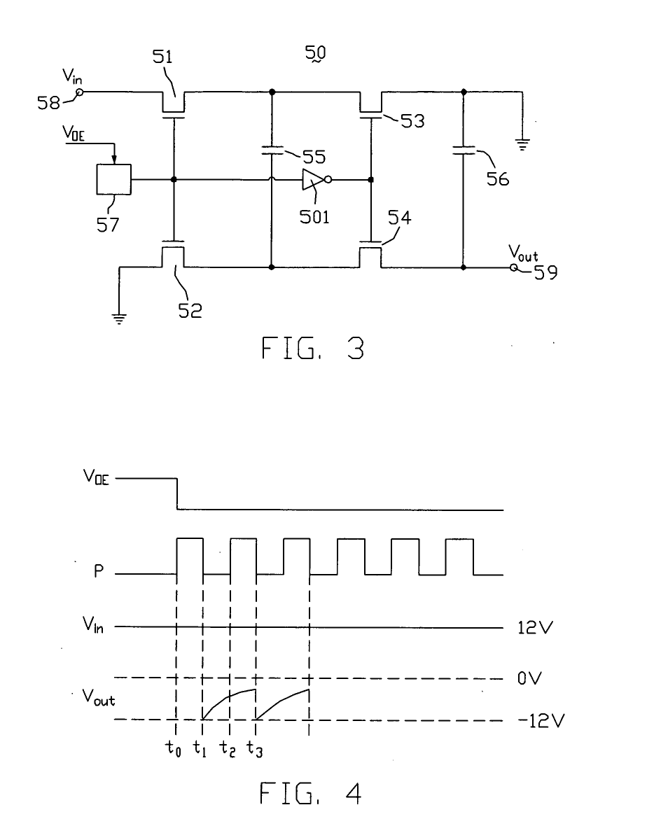

Referring to FIG. 3, a diagram of a negative voltage generating circuit 50 according to a second embodiment of the present invention is shown. The negative voltage generating circuit 50 has a circuit structure similar to that of the negative voltage generating circuit 10. However, the negative voltage generating circuit 50 includes a reverser 501. The reverser 501 is connected between a switch controller 57 and gate electrodes of a third switch transistor 53 and a fourth switch transistor 54. The third and fourth switch transistors 53, 54 are NMOS type transistors. The reverser 501 is configured for reversing a control signal from the switch controller 57 to a signal having a reverse phase.

Referring also to FIG. 4, this shows a schematic timing chart of voltage signals of the negative voltage generating circuit 50 of FIG. 3. The negative voltage generating circuit 50 has a working procedure similar to that of the negative voltage generating circuit 10.

Further or alternative embodiments may include the following. In a first example, the control signal P has a reverse phase, the first and second switch transistors 11, 12 are PMOS type transistors, and the third and fourth switch transistors 13, 14 are NMOS type transistors. In a second example, each of the first to fourth switch transistors 11, 12, 13, 14 can instead be any other suitable kind of switching component or switch, which is operable to be switched on in response to high-level voltage and to be switched off in response to low-level voltage. In a third example, each of the first to fourth switch transistors 11, 12, 13, 14 can instead be any other suitable kind of switching component or switch, which is operable to be switched on in response to low-level voltage and to be switched off in response to high-level voltage. In a fourth example, the first to fourth switch transistors 11, 12, 13, 14 and the switch controller 17 may be integrated in one piece of a printed circuit board (PCB), or designed and manufactured as a single integrated circuit.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A negative voltage generating circuit comprising a voltage input, a first switch transistor, a second switch transistor, a third switch transistor, a fourth switch transistor, a first capacitor, a second capacitor, a switch controller, and a voltage output, the voltage input being connected to ground via a source electrode and a drain electrode of the first switch transistor, the first capacitor, and a source electrode and a drain electrode of the second switch transistor, the drain electrode of the first switch transistor being connected to the source electrode of the second switch transistor via a source electrode and a drain electrode of the third switch transistor, the second capacitor, and a source electrode and a drain electrode of the fourth switch transistor, the drain of the third switch transistor being connected to ground, the source electrode of the fourth switch transistor being connected to the voltage output, the gates of the first switch transistor, the second switch transistor, the third switch transistor, and the fourth switch transistor being connected to the switch controller.

2. The negative voltage generating circuit of claim 1, wherein the first and second switch transistors are N-channel metal oxide semiconductor type transistors, and the third and fourth switch transistors are P-channel metal oxide semiconductor type transistors.

3. The negative voltage generating circuit of claim 1, wherein the first and second switch transistors are P-channel metal oxide semiconductor type transistors, and the third and fourth switch transistors are N-channel metal oxide semiconductor type transistors.

4. The negative voltage generating circuit of claim 1, further comprising a reverser connected between the switch controller and gate electrodes of the third and fourth switch transistors.

5. The negative voltage generating circuit of claim 4, wherein the first, second, third, and fourth switch transistors are the same type of transistor.

6. The negative voltage generating circuit of claim 4, wherein the first, second, third, and fourth switch transistors are N-channel metal oxide semiconductor type transistors.

7. The negative voltage generating circuit of claim 4, wherein the first, second, third, and fourth switch transistors are P-channel metal oxide semiconductor type transistors.

8. The negative voltage generating circuit of claim 1, wherein the switch controller is configured to control the first switch transistor, the second switch transistor, the third switch transistor, and the fourth switch transistor between on and off states.

9. The negative voltage generating circuit of claim 1, wherein the switch controller applies a control signal to the gate electrodes of the first, second, third, and fourth switch transistors.

10. The negative voltage generating circuit of claim 9, wherein the control signal is a sequential, periodic square-wave.

11. The negative voltage generating circuit of claim 1, wherein the voltage output is provided with a positive 12V voltage, the voltage output outputting a negative voltage.

12. A negative voltage generating circuit comprising:
a first capacitor;
a second capacitor; and
a switch circuit being capable of generating a negative voltage from a positive voltage by controlling the first capacitor to be charged or discharged and controlling the second capacitor to be charged or discharged periodically;
wherein the first capacitor is pre-charged for half a cycle period, the first capacitor discharging during a first half of each cycle period and being charged during a second half of each cycle period, and the second capacitor being charged during the first half of each cycle period and discharging during the second half of each cycle period.

13. The negative voltage generating circuit of claim 12, further comprising a voltage input configured for receiving a positive voltage from external circuits and providing the positive voltage to the switch circuit, and a voltage output configured for providing the negative voltage to other external circuits.

14. The negative voltage generating circuit of claim 12, wherein the switch circuit comprises a first switch, a second switch, a third switch, and a fourth switch operable to be switched on in response to high-level voltage and to be switched off in response to low-level voltage.

15. The negative voltage generating circuit of claim 14, wherein the switch circuit further comprises a switch controller configured for providing a control signal to the first switch, the second switch, the third switch, and the fourth switch, the control signal being a periodical, sequential square-wave, and is low-level during the first half of each cycle period and high-level during the second half of each cycle period.

16. The negative voltage generating circuit of claim 12, wherein the switch circuit comprises a first switch, a second switch, a third switch, and a fourth switch operable to be switched on in response to low-level voltage and to be switched off in response to high-level voltage.

17. The negative voltage generating circuit of claim 15, wherein the voltage input is connected to ground via a source electrode and a drain electrode of the first switch, the first capacitor, and a source electrode and a drain electrode of the second switch, the drain electrode of the first switch transistor being connected to the source electrode of the second switch via a source electrode and a drain electrode of the third switch, the second capacitor, a source electrode and a drain electrode of the fourth switch, the drain of the third switch being connected to ground, the source electrode of the fourth switch being connected to the voltage output, and the gates of the first switch, the second switch, the third switch, and the fourth switch being connected to the switch controller.

18. The negative voltage generating circuit of claim 17, wherein the first and second switches are N-channel metal oxide semiconductor type transistors, the third and fourth switches are P-type channel metal oxide semiconductor type transistors.

19. The negative voltage generating circuit of claim 12, wherein the voltage input receives a 12V positive voltage.

20. The negative voltage generating circuit of claim 12, wherein the negative voltage output from the voltage output substantially jumps to −12V at the beginning of each cycle period, and gradually becomes greater from −12V to approximately below 0V during each cycle period.
